(19) United States
(12) Patent Application Publication
(10) Pub. No.: US 2012/0299969 A1
(43) Pub. Date: Nov. 29, 2012

(54) TABLET HAVING A HIERARCHICAL ADJUSTMENT FUNCTION IN SIDE AREA

(75) Inventors: CHIN-YEN CHEN, HSIN-CHU CITY (TW); WEI-CHOU CHEN, HSIN-CHU CITY (TW)

(73) Assignee: WALTOP INTERNATIONAL CORPORATION, HSIN-CHU CITY (TW)

(21) Appl. No.: 13/114,495

(22) Filed: May 24, 2011

(51) Int. Cl. G09G 5/00

(52) U.S. Cl. 345/667

(57) ABSTRACT

A tablet is disclosed having a hierarchical adjustment function in a side area thereof. In particular, a tablet has a rollover function area in a side area for performing the functions of scrolling a framed object, minifying and magnifying a framed object (such as a picture), and adjusting a (sound) volume. A drawing area (or working area) and at least one rollover function area are disposed on the surface of the tablet. The rollover function area is disposed at one side of the drawing area. A user can activate and implement the hierarchical adjustment function only by using an electromagnetic pen to touch the rollover function area and move therein.

### FIELD OF THE INVENTION

The present invention relates to a tablet having a hierarchical adjustment function in a side area thereof, and more particularly to a tablet having a rollover function area in a side area for performing the functions of scrolling a framed object, minifying and magnifying pictures, and adjusting (sound) volume.

### BACKGROUND OF THE INVENTION

FIG. 1 is a plan form diagram illustrating a common and conventional tablet 10. In general, macro instruction unit areas 14, 16 are disposed above and below working area on the tablet 10 for a user to use the tablet 10 conveniently and quickly. Several macro instructions, such as F1-F13, are disposed in the macro instruction unit areas 14, 16. Like hotkeys on a keyboard, when an electromagnetic pen taps or selects one macro instruction, a function and mode, which the macro instruction represents, are activated quickly. Examples include the function and mode for changing color or thickness of words written on the tablet 10 by an electromagnetic pen and the function and mode for changing the background of the tablet 10 or changing the color of the background of the tablet 10. In this way, the user can use the tablet more efficiently and activate a wanted function and mode quickly and conveniently.

Although the use of the electromagnetic pen to select or tap the macro instructions in the macro instruction unit areas 14, 16 can achieve the same effect as the hotkeys on a keyboard, it is not easy to for users to operate these macro instructions to implement hierarchical adjustment functions, such as scrolling the window to view a document or web, minifying and magnifying pictures shown in the tablet 10, adjusting the sound volume of the tablet 10 when the tablet 10 is used to view a document or web, or performing other hierarchical adjustment functions. Frequently, two or more macro instructions are needed to perform a hierarchical adjustment function because many hierarchical adjustment functions can be adjusted in two or more different directions or ways. For example, to manipulate the relative position of a document or web page on the tablet, four macro instructions respectively representing moving left, moving right, moving upward and moving downward are needed. To adjust the size of a picture shown in a tablet, both a magnifying macro instruction and a minifying macro instruction are needed. To adjust the sound volume of the tablet, both a volume-raising macro instruction and a volume-reducing macro instruction are needed. Therefore, to access such a hierarchical adjustment function, the user must typically select or tap several macro instructions. This is inconvenient for the user and reduces the operational efficiency of the tablet.

In view of foregoing drawbacks of the conventional tablet, there is a need for a tablet that facilitates convenient and easy use and operation of the hierarchical adjustment functions of scrolling a framed object, minifying and magnifying pictures, and adjusting (sound) volume.

### SUMMARY OF THE INVENTION

An objective of this invention is to provide a tablet that provides a user with a convenient and easy way to use and operate the hierarchical adjustment functions of scrolling a framed object, minifying and magnifying pictures, and adjusting (sound) volume. The tablet reduces the number and complexity of macro instructions required for using and operating these hierarchical adjustment functions. These innovations improve the convenience and operational efficiency of the tablet.

For overcoming the foregoing drawbacks of the conventional tablet and for achieving the foregoing objective, a tablet having a rollover function area in a side area thereof is provided in this invention. The tablet comprises a drawing area and at least one rollover function area wherein both of the drawing area and the rollover function area are disposed on one surface of the tablet and the rollover function area is disposed at one side of the drawing area. The drawing area provides a region for an electromagnetic pen to write, draw or select a function thereon, and the rollover function area provides a region for an electromagnetic pen to perform a hierarchical adjustment function, for example scrolling an object framed in the drawing area, minifying and magnifying pictures framed in the drawing area, or adjusting a (sound) volume of the tablet. The hierarchical adjustment functions are activated and implemented by defining movements of the electromagnetic pen in different directions in the rollover function area as representing different functions respectively. For example, when the electromagnetic pen is positioned in a rollover function area or subarea configured to scroll an object framed in the drawing area, a right move of the electromagnetic pen moves the object toward the right, and a left move of the electromagnetic pen moves the object toward the left. In this way, fewer hotkeys and function keys are needed to activate and implement the hierarchical adjustment function. This enables users to use and operate the tablet more conveniently and efficiently. More particularly, it makes use of the tablet to view documents and webpages, watch movies, and listen to music easier and more convenient.

### BRIEF DESCRIPTION OF THE DRAWINGS

FIG. 1 is a plan form diagram illustrating a conventional tablet.

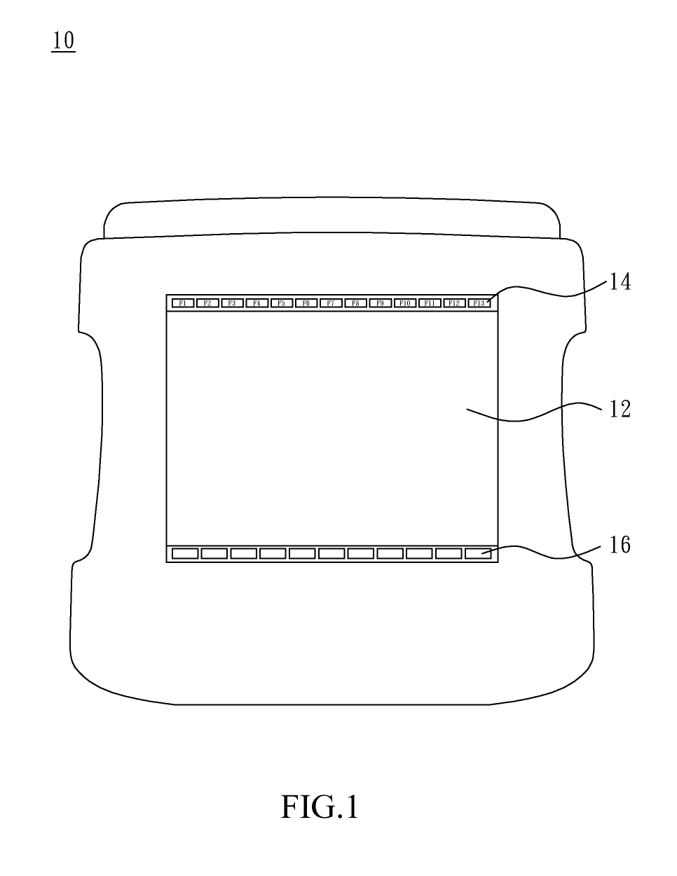

FIG. 2 is a stereoscopic form diagram illustrating a tablet having a rollover function area in a side area thereof in accordance with one embodiment of the present invention.

FIG. 3 is a stereoscopic form diagram illustrating a tablet having a rollover function area in a side area thereof in accordance with another embodiment of the present invention.

FIG. 4 is a stereoscopic form diagram illustrating a tablet having a rollover function area in a side area thereof in accordance with still another embodiment of the present invention.

### DESCRIPTION OF THE EXEMPLARY EMBODIMENTS

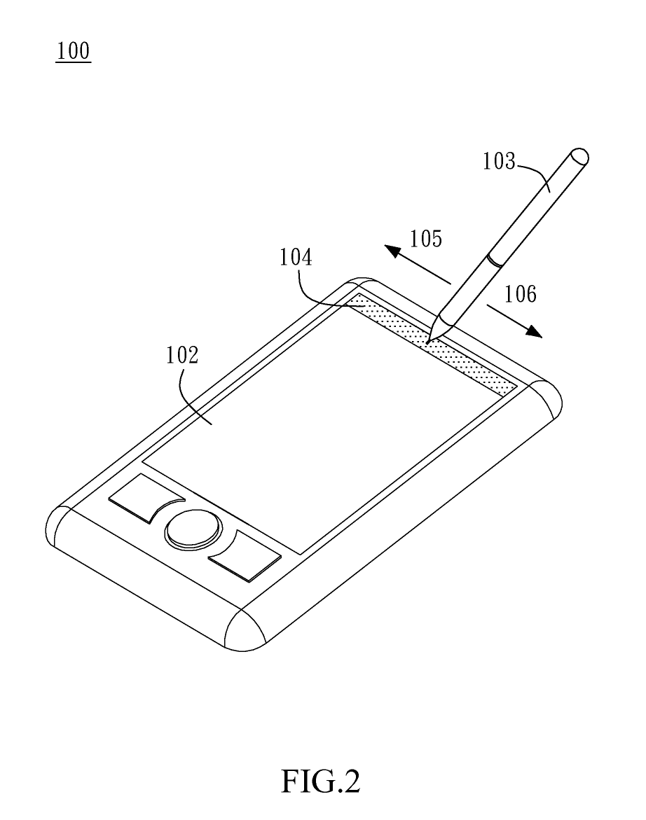

FIG. 2 is a stereoscopic form diagram illustrating a tablet 100 having a rollover function area in a side area thereof in accordance with one embodiment of the present invention. The tablet 100 comprises a drawing area (or working area) 102 and at least one rollover function area 104 disposed at one side of the drawing area 102. For example, the rollover function area 104 is disposed above the drawing area 102 or at the top side of the drawing area 102 in the tablet 100 of this embodiment. Both the drawing area 102 and the rollover function area 104 are disposed on one surface of the tablet 100. The drawing area 102 provides a region for an electromagnetic pen 103 to write, draw or select a function on the drawing area 102. Users can also view documents and webpages and watch movies in the drawing area 102. The electromagnetic pen 103 can also touch and freely move in the rollover function area 104 to activate and perform the hierarchical adjustment functions of scrolling a framed object (such as a document, webpage, or picture), minifying and magnifying the framed object, adjusting a (sound) volume, and/or other hierarchical adjustment functions.

In one embodiment of this tablet 100, the rollover function area 104 disposed above the drawing area 102 is a rollover function area for scrolling or moving an object (such as document or web) framed in the drawing area 102. When the electromagnetic pen 103 touches the rollover function area 104 and moves in the rollover function area 104, the tablet 100 defines, detects, and interprets the movement of the electromagnetic pen 103 in different directions in the rollover function area 104 as representing commands to move the framed object in different directions respectively. Taking FIG. 2, for an example, the tablet 100 defines and interprets a leftward move (following arrow 105) of the electromagnetic pen 103 in the rollover function area 104 as representing a command to move or scroll the object framed in the drawing area 102 toward the left side of the drawing 102. Likewise, the tablet 100 defines and interprets a rightward move (following arrow 106) of the electromagnetic pen 103 in the rollover function area 104 as representing a command to move or scroll the object framed in the drawing area 102 toward the right side of the drawing 102. Accordingly, the object framed in the drawing area 102 moves or scrolls toward the left side of the drawing 102 when the electromagnetic pen 103 moves toward the left (following arrow 105) in the rollover function area 104, and the object framed in the drawing area 102 moves or rolls toward the right side of the drawing 102 when the electromagnetic pen 103 moves toward the right (following arrow 106) in the rollover function area 104. In this embodiment, scrolling or movement of the object framed in the drawing area 102 toward the left or right can only be accomplished through the rollover function area 104.

In another embodiment, the tablet 100 defines the upward move of the electromagnetic pen 103 in the rollover function area 104 as representing a command to move or scroll the object framed in the drawing area 102 toward the top side of the drawing 102 and defines the downward move of the electromagnetic pen 103 in the rollover function area 104 as representing a command to move or scroll the object framed in the drawing area 102 toward the bottom side of the drawing 102. Accordingly, the object framed in the drawing area 102 moves or scrolls toward the top side of the drawing 102 when the electromagnetic pen 103 moves upward in the rollover function area 104, and the moves or scrolls toward the bottom side of the drawing 102 when the electromagnetic pen 103 moves downward in the rollover function area 104. In this embodiment, only the rollover function area 104 only can control the object framed in the drawing area 102 to move or roll upward and downward. Or, in one embodiment of this invention, the tablet 100 defines the upward move, downward move, left move and right move of the electromagnetic pen 103 in the rollover function area 104 to respectively represent moving or scrolling the object framed in the drawing area 102 upward, downward, toward left or toward right. In this embodiment, scrolling or movement of the object framed in the drawing area upward or downward can only be accomplished within the rollover function area 104.

In another embodiment, two rollover function areas are disposed along different orthogonal sides of the drawing area, for example a top side and right side, a top side and left side, a bottom side and right side, or a bottom side and left side. The two rollover function areas are respectively used to move or scroll the object framed in the drawing area upward or downward and left or right. Regardless of which of the foregoing configurations is adopted, the longer distance the electromagnetic pen moves, the longer distance the object framed in the drawing area is moved. Accordingly, the tablet 100 directly controls the object framed in the drawing area 102 to move upward, downward, left, and right by moving the electromagnetic pen 103 in different directions in the rollover function area 104. Unlike the conventional tablet, there is no need of four separate hotkeys to represent and cause upward moves, downward moves, left moves and right moves. Therefore, it is more convenient and efficient for users to use and operate the tablet.

In another embodiment of this tablet 100, the rollover function area 104 disposed above the drawing area 102 is a rollover function area for minifying and magnifying an object (such as a picture) framed in the drawing area 102. When the electromagnetic pen 103 touches the rollover function area 104 and move in the rollover function area 104, The tablet 100 defines and interprets different directions and extents of movement of the electromagnetic pen 103 in the rollover function area 104 as representing respective commands to minify or magnify the object framed in the drawing area 102 to different degrees. Taking FIG. 2, for an example, the tablet 100 defines the left move (following arrow 105) of the electromagnetic pen 103 in the rollover function area 104 to represent minifying the object framed in the drawing area 102. Likewise, the tablet 100 defines the right move (following arrow 106) of the electromagnetic pen 103 in the rollover function area 104 to represent magnifying the object framed in the drawing area 102. Accordingly, objects framed in the drawing area 102 are minified when the electromagnetic pen 103 moves toward the left (following arrow 105), and the object framed in the drawing area 102 is magnified when the electromagnetic pen 103 moves toward the right (following arrow 106). The farther the electromagnetic pen 103 travels toward the left, the more the object framed in the drawing area 102 is minified. The farther the electromagnetic pen 103 travels toward the right, the more the object framed in the drawing area 102 is magnified.

In an alternative embodiment of this invention, the tablet 100 defines the left move of the electromagnetic pen 103 in the rollover function area 104 to represent magnifying the object framed in the drawing area 102 and the right move of the electromagnetic pen 103 in the rollover function area 104 to represent minifying the object framed in the drawing area 102. In yet another embodiment of this invention, the tablet 100 defines the upward and downward moves of the electromagnetic pen 103 in the rollover function area 104 as respectively representing minifying and magnifying the object framed in the drawing area 102. Accordingly, the tablet 100 directly minifies and magnifies the object framed in the drawing area 102 in response to movements of the electromagnetic pen 103 in different directions in the rollover function area 104. Unlike the conventional tablet, there is no need of two hotkeys to represent the minifying and magnifying functions. Therefore, it is more convenient and efficient for users to use and operate the tablet.

Similarly, in one embodiment of this tablet 100, the rollover function area 104 disposed above the drawing area 102 is a rollover function area for adjusting the (sound) volume of the tablet 100. When the electromagnetic pen 103 touches the rollover function area 104 and moves in the rollover function area 104, the tablet 100 defines and inteprets different directions and extents of movements of the electromagnetic pen 103 in the roll function area 104 to respectively represent raising and reducing the (sound) volume of the tablet 100 to different degrees. Taking FIG. 2, for an example, the tablet 100 defines the left move (following arrow 105) of the electromagnetic pen 103 in the rollover function area 104 to represent reducing the (sound) volume of the tablet 100 and defines the right move (following arrow 106) of the electromagnetic pen 103 in the rollover function area 104 to represent raising the (sound) volume of the tablet 100. Accordingly, the (sound) volume of the tablet 100 is reduced when the electromagnetic pen 103 moves toward the left (following arrow 105) in the rollover function area 104, and the (sound) volume of the tablet 100 is raised when the electromagnetic pen 103 moves toward the right (following arrow 106) in the rollover function area 104. The farther the electromagnetic pen 103 moves toward left, the more the (sound) volume of the tablet 100 is reduced. The farther the electromagnetic pen 103 moves toward the right, the more the (sound) volume of the tablet 100 is raised.

In an alternative embodiment of this invention, the tablet 100 defines the left move of the electromagnetic pen 103 in the rollover function area 104 to represent raising the (sound) volume of the tablet 100 and the right move of the electromagnetic pen 103 in the rollover function area 104 to represent reducing the (sound) volume of the tablet 100. In another alternative embodiment of this invention, the tablet 100 defines the upward and downward moves of the electromagnetic pen 103 in the rollover function area 104 to respectively represent raising and reducing the (sound) volume of the tablet 100 to different degrees. Accordingly, the tablet 100 directly raises and reduces the (sound) volume of the tablet 100 in response to movements of the electromagnetic pen 103 in different directions in the rollover function area 104. Unlike the conventional tablet, there is no need for two hotkeys to represent the volume-raising and reducing functions. Therefore, it is more convenient and efficient for users to use and operate the tablet.

Any other hierarchical adjustment function can be defined in the rollover function area 104 by any kind of the foregoing methods in order to reduce the requirement for hotkeys and to improve the convenience for using the tablet. Furthermore, any defined move of the electromagnetic pen 103 in different directions in the rollover function area 104 is pre-installed or pre-set in the tablet 100. Also, the rollover function area 104 can be disposed at any of the sides of the drawing area 102, for example the bottom side, the left side or the right side.

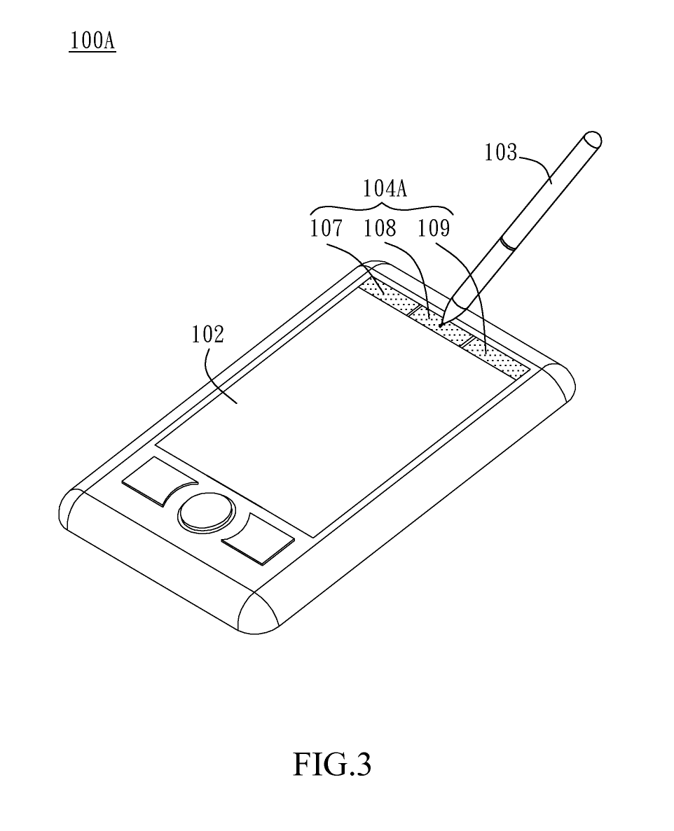

FIG. 3 is a stereoscopic form diagram illustrating a tablet 100A having a rollover function area in a side area thereof in accordance with another embodiment of the present invention. The structure of the tablet 100A illustrated in FIG. 3 is substantially similar to the structure or the tablet 100 illustrated in FIG. 2. Like the tablet 100, tablet 100A has a drawing area 102 and a rollover function area 104A disposed on one surface of the tablet 100A, and the rollover function area 104A is disposed above the drawing area 102. The difference between the tablet 100A and the tablet 100 is that the rollover function area 104A on the tablet 100A is divided into three function areas. The three function areas comprises a framed object scrolling area 107, a picture (or other object) minifying and magnifying area 108, and a sound volume adjusting area 109. These three function areas have, respectively, the hierarchical adjustment functions of scrolling (or moving) the framed object, minifying and magnifying the framed object, and adjusting the (sound) volume of the tablet 100A. Each of the function areas of the tablet 100A adopts the same method with the tablet 100 illustrated in FIG. 2 to define the rollover function area 104A, and the actions between the three function areas and the electromagnetic pen 103 are the same with the actions between the rollover function area 104 and the electromagnetic pen 103 of the tablet 100 illustrated in FIG. 2. All of them are detailed above, so they are not described herein, again.

While FIG. 3 depicts a rollover function area 104A disposed above the drawing area 102, the rollover function area 104A can be disposed at other sides of the drawing area 102, such as the bottom side, the left side, or the right side, according to requirements. Furthermore, the rollover function area 104A can be divided into different, fewer and/or more function areas for omitting unwanted hierarchical functions or substituting or adding other hierarchical adjustment functions.

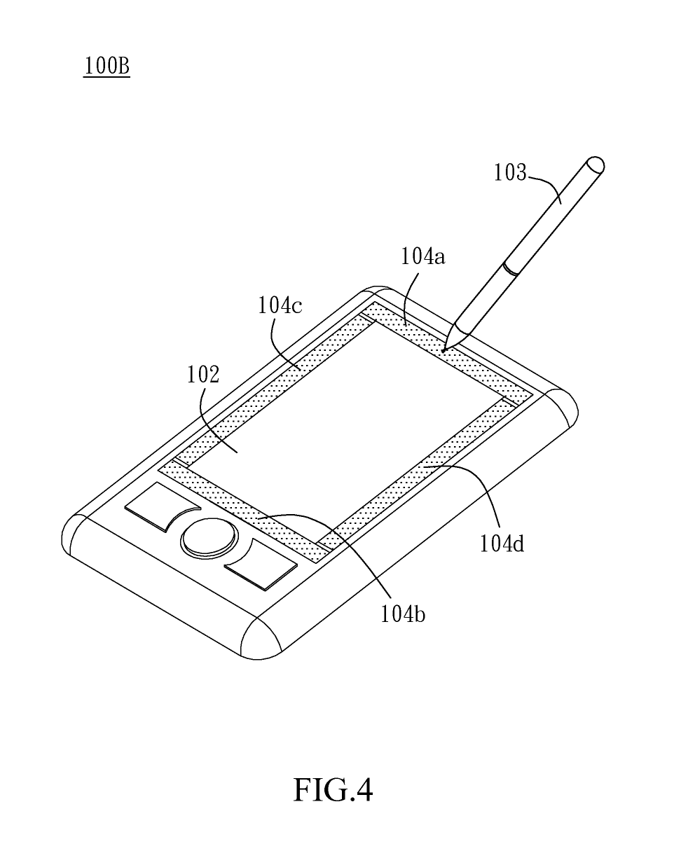

FIG. 4 is a stereoscopic form diagram illustrating a tablet 100B having a rollover function area in a side area thereof in accordance with still another embodiment of the present invention. The tablet 100B also has a drawing area 102, which is disposed on one surface of the tablet 100B for the electromagnetic pen to write, draw, and select a function. The difference between the tablet 100B and the tablets 100 and 100A illustrated in FIG. 2 and is that there are four rollover function areas disposed at the four sides of the drawing area 102 of the tablet 100B, respectively. Therefore, the tablet 100B has a first rollover function area 104a, a second rollover function area 104b, a third rollover function area 104c and a fourth rollover function area 104d that are respectively disposed at the top side, the bottom side, the left side and the right side of the drawing area 102. The first rollover function area 104a, the second rollover function area 104b, the third rollover function area 104c and the fourth rollover function area 104d have the respective functions of moving (or scrolling) the object framed in the drawing area 102 toward left and right, adjusting the (sound) volume of the tablet 100B, minifying and magnifying the object framed in the drawing area 102, and moving (or scrolling) the object framed in the drawing area 102 upward and downward. This configuration is just one of many possible configurations, and it is not intended to be limiting. In another embodiment of this invention, the first rollover function area 104a, the second rollover function area 104b, the third rollover function area 104c and the fourth rollover function area 104d have different functions, and the arrangement of the first rollover function area 104a, the second rollover function area 104b, the third rollover function area 104c and the fourth rollover function area 104d can be changed according to different designs and requirements. Also, one or some of the first rollover function area 104a, the second rollover function area 104b, the third rollover function area 104c and the fourth rollover function area 104d can be omitted for reducing the rollover function area.

In yet another embodiment of this invention, both the rollover function area 104 of the tablet 100 illustrated in FIG. 2 and the rollover function area 104A of the tablet 100A illustrated in FIG. 3 are adopted to perform different hierarchical adjustment functions, and they are disposed at different sides of the drawing area on the tablet of this invention. Therefore, the tablet has different kinds of rollover function areas at different sides of the drawing area. It increases the convenience of the tablet to have different kinds of hierarchical adjustment functions.

Therefore, a tablet having a rollover function area in a side area thereof is provided in this invention. The objective of reducing the number and complexity of function keys or hotkeys is achieved by disposing a rollover function area at a side area of the drawing area (or working area), by defining different rollover function areas to perform different hierarchical adjustment functions, and by defining the movement of the electromagnetic pen in different directions in the rollover function area to perform different functions. In this way, the user can contact and move the electromagnetic pen in the rollover function area to activate and implement the hierarchical adjustment functions of scrolling the frame, minifying and magnifying pictures, and adjusting (sound) volume. Therefore, it is more convenient and efficient for the user to use the tablet.

Although the present invention is described in accordance with the embodiments shown as above, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A tablet having a rollover function area in a side area, comprising:
a drawing area for an electromagnetic pen to write, draw or select a function thereon; and
at least one rollover function area disposed at one side of said drawing area wherein said drawing area and said rollover function area are disposed on one surface of said tablet;
wherein the tablet is responsive to contact and movement of an electromagnetic pen in said rollover function area to perform one or more of the hierarchical adjustment functions of scrolling an object framed in the drawing area, minifying and magnifying the object, and adjusting volume.

2. The tablet of claim 1, wherein said rollover function area is disposed above said drawing area.

3. The tablet of claim 1, wherein said rollover function area is disposed below said drawing area.

4. The tablet of claim 1, wherein said rollover function area is disposed at a right side of said drawing area.

5. The tablet of claim 1, wherein said rollover function area is disposed at a left side of said drawing area.

6. The tablet of claim 1, wherein said rollover function area is divided into several function areas.

7. The tablet of claim 6, wherein said function areas comprise a framed object scrolling area responsive to contact and movement of an electromagnetic pen in said framed object scrolling area to move and scroll the object framed in said drawing area.

8. The tablet of claim 6, wherein said function areas comprise a picture minifying and magnifying area responsive to contact and movement of an electromagnetic pen in said picture minifying and magnifying area to cause said tablet to minify and magnify a picture framed in said drawing area.

9. The tablet of claim 6, wherein said function areas comprise a volume adjusting area responsive to contact and movement of an electromagnetic pen in said volume adjusting area to control a sound volume of said tablet.

10. The tablet of claim 1, wherein said tablet comprises four rollover function areas respectively disposed at a top side, a bottom side, a left side and a right side of said drawing area, said rollover function areas being responsive to contact and movement of an electromagnetic pen in respective ones of said areas to move an object framed in said drawing area, adjust a sound volume of said tablet, and minify and magnify a picture framed in said drawing area.
